(19) United States
(12) Patent Application Publication
(10) Pub. No.: US 2008/0141313 A1
(43) Pub. Date: Jun. 12, 2008

(54) AUTHENTICATION BOOTSTRAP BY NETWORK SUPPORT

(76) Inventors: Ryoji Kato, Kanagawa (JP); Toshikane Oda, Tokyo (JP); Shingo Murakami, Kanagawa (JP)

Correspondence Address: ERICSSON INC., 6300 LEGACY DRIVE, M/S EVR 1-C-11, PLANO, TX, 75024, US

(21) Appl. No.: 11/947,576

(22) Filed: Nov. 29, 2007

Related U.S. Application Data
(60) Provisional application No. 60/868,828, filed on Dec. 6, 2006.

(51) Int. Cl. H04N 7/16

(52) U.S. Cl. 725/62

(57) ABSTRACT

An authoritative server and method are described herein that enable a person to use a Video-on-Demand (VoD) service subscription on their mobile phone (e.g., user device) to have a service operator (e.g., IMS operator) stream a video to a target device (e.g., TV terminal, computer terminal) instead of to their mobile phone.

### CLAIM BENEFIT OF PRIOR FILED U.S. APPLICATION

This application claims the benefit of U.S. Provisional Patent Application Ser. No. 60/868,828 which was filed on Dec. 6, 2006 the contents of which are hereby incorporated by reference herein.

### TECHNICAL FIELD

The present invention relates to an authoritative server and method for enabling a person to use a VoD service subscription on their mobile phone (e.g., user device) and have a service operator (e.g., IMS operator) stream a video to a target device (e.g., TV terminal, computer terminal) instead of to their mobile phone.

### BACKGROUND

The following abbreviations are herewith defined, at least some of which are referred to within the following description of the prior art and the present invention.

### AP Access Point

### DLNA Digital Living Network Alliance

### HTTPS Hypertext Transfer Protocol Security

### ID Identifier

### IMPU IP Multimedia Public Identity

### IMS IP Multimedia Subsystem

### IP Internet Protocol

### IPv6 Internet Protocol version 6

### ISIM IP Multimedia Services Identity Module

### LAN Local Area Network

### MANA Manual Authentication

### ME Mobile Equipment

### MN Mobile Node

### P-CSCF Proxy-Cell Session Control Function

### PIN Personal Identity Number

### SIM Subscriber Identity Module

### SIP Session Initiation Protocol

### TLS Transport Layer Security

### TV Television

### UICC Universal Integrated Circuit Card

### URI Uniform Resource Identifier

### USIM Universal Subscriber Identity Module

### VoD Video on Demand

### WLAN Wireless Local Area Network

A mobile phone user today may want to use a VoD service subscription on their mobile phone to have a remote service operator (e.g., IMS operator) stream a video (e.g., IMS video) to a target device (e.g., TV terminal, computer terminal) instead of to their mobile phone. This type of service can be accomplished after the mobile phone and the target device establish a pairing relationship such that the necessary credentials of the VoD service subscription can be passed from the mobile phone to the target device which enables the service operator to stream the desired video towards the target device. There are several known schemes that could be adapted to be used in this type of application to help establish this particular pairing relationship between the mobile phone and target device.

Some of these known schemes and their associated drawbacks are briefly discussed next:

### PIN Code (Reference No. 1)

A user inputs the same PIN code into both the mobile phone and the target device (this scheme assumes that the target device has an input device). Then, a secure connection between the mobile phone and the target device can be established by using the PIN code as a shared secret key. This solution has several drawbacks some of which are as follows (for example):

1) The encryption by the PIN code (several digits) is not very secure. If there is a malicious man-in-the-middle device located between the mobile phone and the target device, then the PIN code could be cracked. For example, according to reference no. 1, a 4-digit PIN can be cracked in less than 0.3 sec on an old Pentium III 450 MHz computer terminal, and the same 4-digit PIN can be cracked in 0.06 sec on a Pentium IV 3 GHz computer terminal (note: this reference and other references are identified at the end of this document).

2) The security level could be easily decreased by the user's behavior. If the user selects the PIN code like 88888888, 01234567, etc . . . , then PIN code could easily be cracked by a malicious man-in-the-middle device.

3) If one used a secure long PIN code that is not easily guessed, then it would be difficult to input such a long PIN code (or password) into the target device. This is especially true if the person had to use a simple input device such as a video game controller etc . . . to input the long PIN code into the target device. For example, if the long secure PIN code can be selected from 0-9 and a-f (16 characters=4 bits) then 32 characters must be inputted for a 128-bit key. If the long secure PIN code can be selected from a-z, A-Z, 0-9, +, and − (64 characters=6 bits) then 22 characters must be inputted for a 128-bit key. As can be seen, the use of long PIN codes can be a secure solution but the input of the long PIN codes degrade the user experience.

### Transport Layer Security (TLS)

In this scheme, assume the mobile phone and target device have no knowledge about each other beforehand. So, both the mobile phone and target device can verify the validation of each others TLS certificate by using a root certificate. However, both the mobile phone and the target device cannot authenticate (e.g., checking MD5 fingerprint, common name etc) each other because they don't know each other beforehand. As such, the TLS scheme is vulnerable against a malicious man-in-the-middle device.

### 3GPP Key Establishment (Reference No. 2)

The key establishment scheme described in the 3GPP TS 33.110 V1.0.0 standard (reference no. 2) assumes that the target device is part of a UICC Hosting Device (which is the mobile phone). This is not always a correct assumption. The 3GPP TS 33.110 V1.0.0 standard can also be used if there is a communication channel between a UICC Hosting Device (which is the mobile phone) and a ME (which is the target device). However, it is not correct to assume that this communication channel is always secure before a 3GPP key is established between the UICC Hosting Device (mobile phone) and the ME (target device). Because, a malicious man-in-the-middle device could easily hijack the communication channel between the UICC Hosting Device (mobile phone) and the ME (target device) prior to the establishment of the 3GPP key. In particular, the 3GPP TS 33.110 V1.0.0 standard does not provide a function which can authenticate the target device as being the right device that the user of the mobile phone wants to establish a connection therewith.

### Talking-To-Strangers (Reference No. 3)

The talking-to-strangers scheme is discussed in reference no. 3. Unfortunately, this scheme requires that a location-limited channel (e.g., short-range wireless channel) be established between the mobile phone and the target device. This is problematic since both the mobile phone and the target device would need to have specialized hardware/software to establish the location-limited channel.

### Seeing-Is-Believing (Reference No. 4)

In this scheme, one device (e.g., target device) displays a barcode and the other device (e.g., mobile phone) reads the barcode to obtain the credential of the former device (e.g., target device). This solution enables the establishment of a secure channel between the two devices. However, this solution is problematic since the mobile phone would need to have specialized hardware/software to capture the barcode.

### Manual Authentication (Reference No. 5)

Manual authentication techniques known as MANA and MANual Authentication are introduced in reference no. 5. These manual authentication techniques require the user to manually transfer the data between the two devices. Unfortunately, the user's manual operation (e.g. copying data manually, entering the same data in both devices etc.) is complicated and time consuming.

From the foregoing, it can be seen that there is a need and has been a need to overcome the above mentioned limitations and drawbacks of the known pairing relation techniques such that a person can use a VoD service subscription on their mobile phone to have a service operator stream a video to a target device (e.g., TV terminal, computer terminal) without having a malicious man-in-the-middle device eavesdrop, tamper, or otherwise abuse the streaming session. This need and other needs are satisfied by the present invention.

### SUMMARY

In one aspect, the present invention provides a method that enables a person to use a service subscription on a user device (e.g., mobile phone) and have a service operator stream a video to a target device (e.g., TV terminal, computer terminal). The method comprising the steps of: (a) enabling a first secure channel to be established between an authoritative server and the target device; (b) enabling a second secure channel to be established between the authoritative server and the user device; (c) enabling the authoritative server to interface with a database and use information associated with the second secure channel to obtain a user identity of the user device; (d) enabling the authoritative server to forward the user identity to the target device which displays the user identity so the user identity can be selected by a user of the user device; (e) enabling the authoritative server to use the first secure channel to transfer a shared secret key to the target device; (f) enabling the authoritative server to use the second secure channel to transfer the shared secret key to the user device; (g) enabling a third secure channel to be established between the target device and the user device by using the shared secret keys; (h) enabling the user device to transfer credential data associated with the service subscription over the third secure channel to the target device; (i) and enabling the target device to send the credential data to the service operator which then streams the video to the target device.

In another aspect, the present invention provides an authoritative server that implements a method comprising the steps of: (a) receiving a session ID request over a first secure channel from a user device (e.g., mobile phone) where the session ID request was originated at a target device (e.g., TV terminal, computer terminal); (b) sending a session ID over the first secure channel to the user device which in turn forwards the session ID to the target device; (c) establishing a second secure channel with the target device; (d) receiving a user ID request over the second secure channel from the target device; (e) obtaining a user identifier associated with the user device; (f) sending the user identifier over the second secure channel to the target device which then displays the user identifier to be selected by a user of the user device; (g) receiving a key distribution request over the second secure channel from the target device; (h) sending a shared secret key over the second secure channel to the target device; (i) receiving a key distribution request over the first secure channel from the user device after the user interacts with the user device; and (j) sending the shared secret key over the first secure channel to the user device, wherein the user device and the target device use the shared secret key to establish a third secure channel between them on which the user device transfers credential data to the target device which then sends the credential data to the service operator which then streams the video to the target device.

In yet another aspect, the present invention provides a target device (e.g., TV terminal, computer terminal) that implements a method comprising the steps of: (a) sending a session ID request to a user device (e.g., mobile phone) which then sends the session ID request over a first secure channel to an authoritative server; (b) receiving a session ID from the user device which received the session ID over the first secure channel from the authoritative server; (c) establishing a second secure channel with the authoritative server; (d) sending a user ID request over the second secure channel to the authoritative server; (e) receiving a user identifier associated with the user device over the second secure channel from the authoritative server; (f) displaying the user identifier so the user identifier can be selected by a user of the user device, (g) sending a key distribution request over the second secure channel to the authoritative server after the user selects the displayed user identifier; (h) receiving a shared secret key over the second secure channel from the authoritative server; (i) using the shared secret key to establish a third secure channel with the user device which previously received the shared secret key over the first secure channel from the authoritative server; (j) receiving credential data over the third secure channel from the user device; (k) sending the credential data to the service operator; and (l) receiving the video from the service operator.

In yet still another aspect, the present invention provides a user device (e.g., mobile phone) that implements a method comprising the steps of: (a) receiving a session ID request from a target device (e.g., TV terminal, computer terminal) and forwarding the session ID request over a first secure channel to an authoritative server; (b) receiving a session ID over the first secure channel from the authoritative server and forwarding the session ID to the target device, wherein the target device: establishes a second secure channel with the authoritative server; sends a user ID request over the second secure channel to the authoritative server; receives a user identifier associated with the user device over the second secure channel from the authoritative server; displays the user identifier so the user identifier can be selected by a user of the user device; sends a key distribution request over the second secure channel to the authoritative server after the user selects the displayed user identifier; and receives a shared secret key over the second secure channel from the authoritative server; (c) sending a key distribution request over the first secure channel to the authoritative server; (d) receiving the shared secret key over the first secure channel from the authoritative server; (e) using the shared secret key to establish a third secure channel with the target terminal; and (f) sending credential data over the third secure channel to the target device which then sends the credential data to the service operator and receives the video from the service operator.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIG. 1 is a block diagram that is used to help explain an exemplary target scenario where a person can use a VoD service subscription on their mobile phone and have a IMS operator stream an IMS video to a target device (e.g., TV terminal, computer terminal) in accordance with the present invention;

FIG. 2 is a flowchart illustrating the basic steps of a preferred method for enabling the person to use the VoD service subscription on their mobile phone and have the IMS operator stream the IMS video to the target device (e.g., TV terminal, computer terminal) in accordance with the present invention; and

FIGS. 3A-3C are three diagrams which are used to help explain an exemplary sequence of the preferred method shown in FIG. 2 in accordance with one embodiment of the present invention.

### DETAILED DESCRIPTION

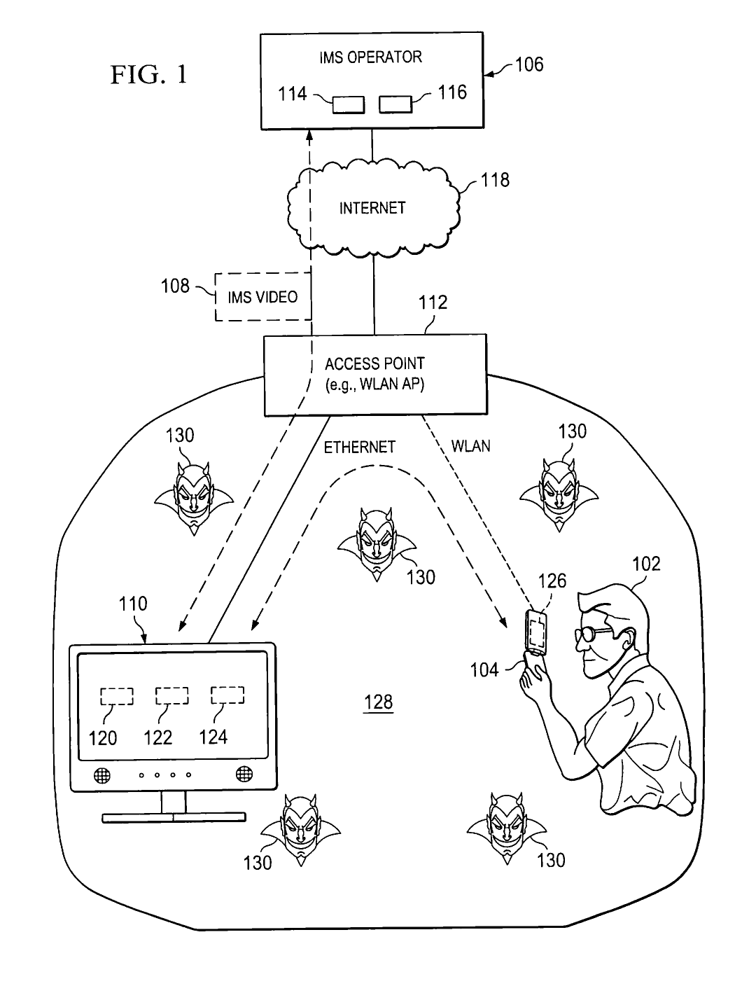

Referring to FIG. 1, there is a block diagram that is used to help explain an exemplary target scenario where a person 102 can use a VoD service subscription on their mobile phone 104 and have an IMS operator 106 stream an IMS video 108 to a target device 110 (e.g., TV terminal 110, computer terminal 110) in accordance with the present invention. In this exemplary scenario, the mobile phone 104 (which has an ISIM or an USIM) interacts with an access point 112 via a WLAN connection (for example) while the target device 110 interacts with the access point 112 via an Ethernet connection (for example). The IMS operator 106 (which in this example has a co-located authoritative server 114 and a user profile database 116) is connected to the access point 112 by the Internet 118. Several assumptions about the different capabilities and features of the mobile phone 104 and the target device 110 are discussed below before a preferred method 200 is described.

1. The target device 110 has an IMS VoD application 120 and is currently connected to the access point 112. The target device 110 is assumed not have a computer virus or malicious software. If desired, the target device 110 can be certified by a vendor or other authority to be free of a computer virus or malicious software.

2. The mobile phone 104 and the target device 110 do not have any advance knowledge of each other. Thus, the present invention can be applied in the case where the two devices 104 and 110 are interconnected locally or remotely on an ad-hoc manner.

3. The target device 110 has no ISIM (or USIM) as a subscription to the IMS operator 106 (or IMS service provider 106). The target device 110 does not have any credentials (e.g., shared secret key with the mobile phone 104) that can be used by the mobile phone 104 to set up a secure communication link with the target device 110.

4. The target device 110 has an output device 122 that can display the user's identifier (e.g., SIP URI, or telephone number). In addition, the target device 110 has an input device 124 that allows the user 102 to select their own identifier (e.g., SIP URI, or telephone number) if different identifiers are displayed on the output device 122.

5. The mobile phone 104 has an input device 126 by which the user 102 can indicate the successful conclusion of the procedure by e.g., pushing an OK button (discussed in more detail below).

6. The mobile phone 104 and the target device 110 can establish a connection with each other via any kind of device control protocol (e.g. DLNA).

7. The user 102 discovers e.g. an IMS VoD application on the TV terminal, and starts to use the IMS VoD service (the service discovery can be by any protocol).

8. The mobile phone 104 has an ISIM (or USIM) as a subscription to the IMS operator 106 (or service provider 106) which could be used to establish a secure connection (e.g. IPsec) with the IMS operator 106 according to the IMS standards that are specified in 3GPP TS 33.203.

8. The mobile phone 104 and the target device 110 are connected to an insecure network 128 such that any kind of man-in-the-middle devices 130 (or other eavesdropping devices 130) could be placed in the network 128. Especially, the preferred method 200 discussed below assumes the network 128 between the IMS operator 106 and the target device 110 is insecure and that it is not necessary for the IMS operator 106 to authenticate the target device 110.

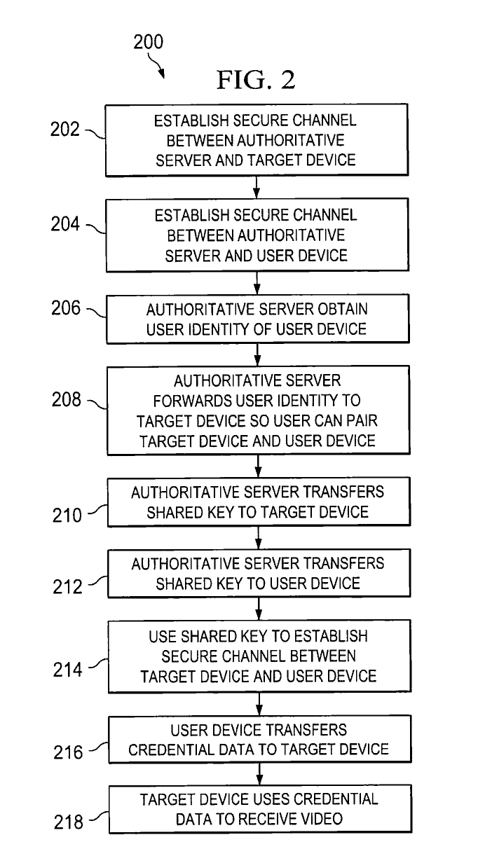

Referring to FIG. 2, there is a flowchart illustrating the basic steps of the preferred method 200 for enabling a person 102 to use a VoD service subscription on their mobile phone 104 and have an IMS operator 106 stream an IMS video 108 to a target device 110 in accordance with the present invention. In this scheme, the IMS operator 106 has a trusted 3^{rd} party (referred to herein as the authoritative server 114) that distributes authentication data and shared secret keys to the mobile phone 104 and the target device 110. The authoritative server 114 is shown as being co-located with the IMS operator 106. However, the authoritative server 114 can be a stand alone unit that is independent from the IMS operator 106. In this example, the network 128 that inter-connects the mobile phone 104, the target device 110 and the authoritative server 114 is assumed to be insecure. As such, the mobile phone 104, the target device 110 and the authoritative server 114 may be prone to manipulation by an active attacker 130, and the traffic to and from the target device 100 could be tampered and eavesdropped without the use of the preferred method 200.

The method 200 has at step 202 where a first secure channel is established between the authoritative server 114 and the target device 110 without the authoritative server 114 having to authenticate the target device 110. At step 204, a second secure channel is established between the authoritative server 114 and the mobile phone 104 after a mutual authentication between the IMS operator 106 and the mobile phone 104 (note: the second secure channel can be an IPsec tunnel between the mobile phone 104 and a P-CSCF if the authoritative server 114 is an IMS application server 114).

At step 206, the authoritative server 114 interfaces with the user profile database 116 and uses information associated with the second secure channel to obtain a user identity e.g., user's telephone number or SIP URI (IMPU) of the mobile phone 104. At step 208, the authoritative server 114 forwards the user identity to the target device 110 which displays the user identity so the person 102 could select the correct mobile phone 104 that is available in the network 128 to authenticate the right pairing of the mobile phone 104 and target device 110.

At step 210, the authoritative server 114 uses the first secure channel to transfer a shared secret key and authentication data to the target device 110 where the shared secret key and authentication data will be subsequently used between the mobile phone 104 and the target device 110 (note: this assumes step 208 was successful). At step 212, the authoritative server 114 uses the second secure channel to transfer a shared secret key and authentication data to the mobile phone 104 where the shared secret key and authentication data will be subsequently used between the mobile phone 104 and the target device 110 (note: this assumes step 208 was successful).

At step 214, the target device 110 and the mobile phone 104 use their shared keys to establish a secure channel between themselves. At step 216, the mobile phone 104 transfers the credential data (e.g. a certified ticket to view a particular video stream etc . . . ) over the established secure channel to the target device 110. At step 218, the target device 110 sends the credential data (e.g., certified ticket) to the IMS operator 106 which then streams the desired video to the target device 100.

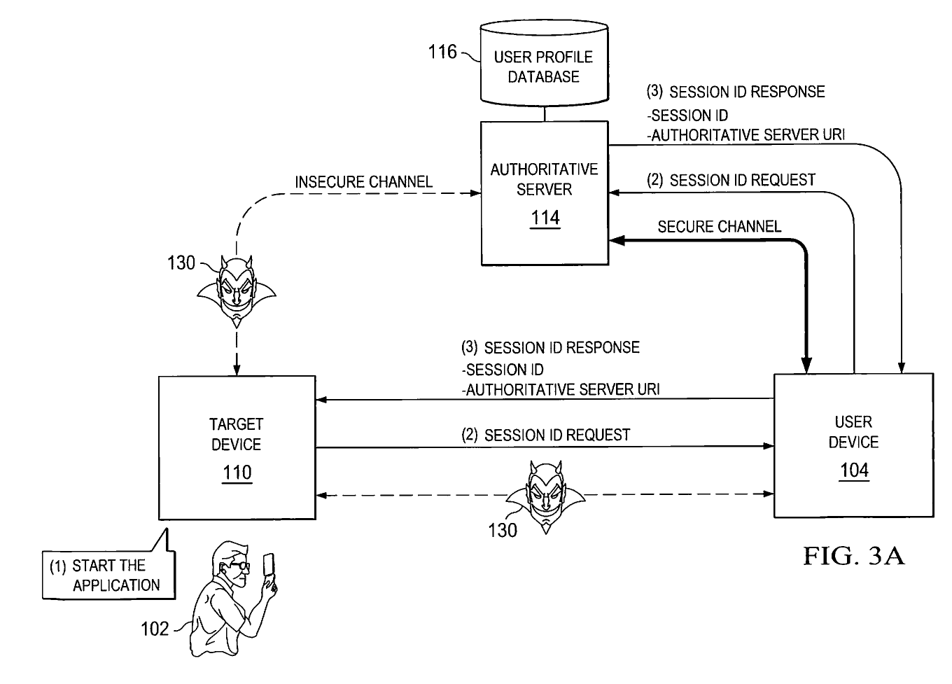

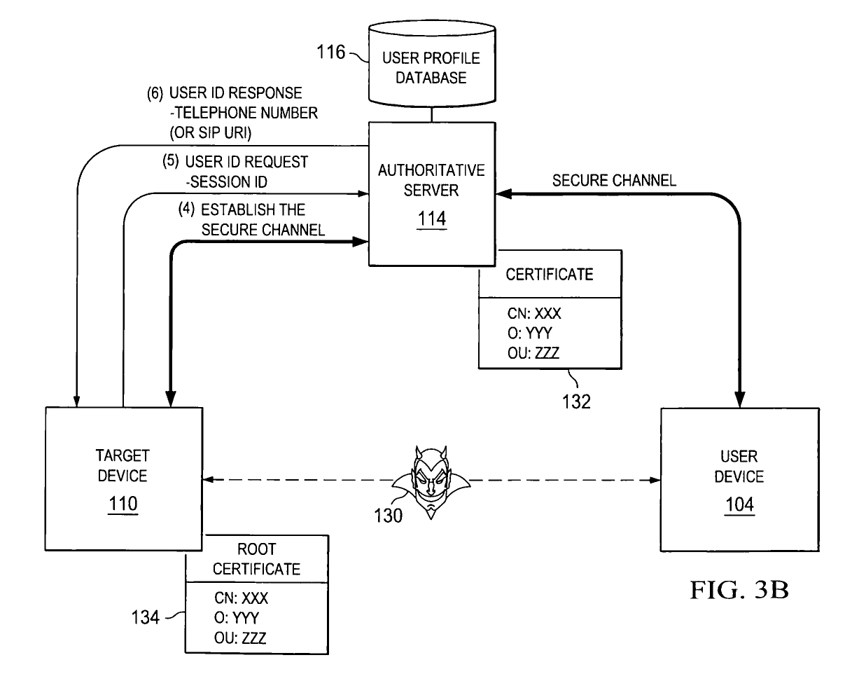

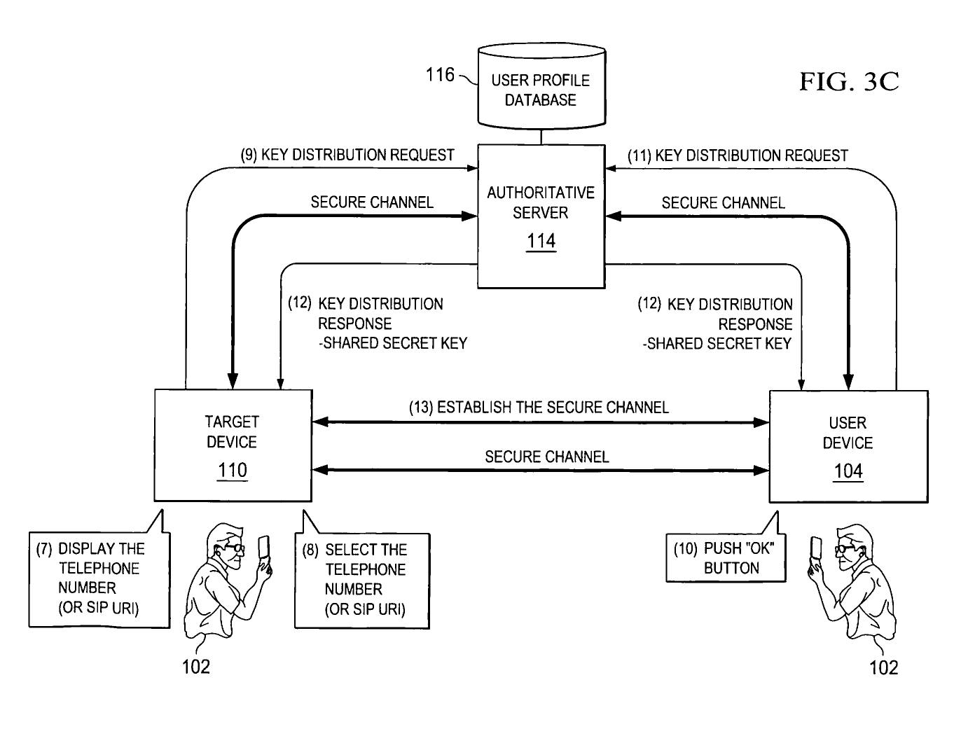

Referring to FIGS. 3A-3C, there are three diagrams which are used to help explain an exemplary sequence of the preferred method 200 in accordance with one embodiment of the present invention. The exemplary sequence of the method 200 is as follows:

Step (1) (see FIG. 3A): The user 102 interacts with the target device 110 to start the application of bootstrapping the authentication between the mobile phone 104 and the target device 110. The target device 110 is assumed to have a video application 120 (e.g., IMS VoD application 120).
Step (2): The target device 110 sends a Session ID Request to the mobile phone 104. The Session ID Request may be broadcast in the network 128 if the target device 110 does not know the address of the mobile phone 104. If there are multiple mobile phones 104 in the network 128 then they may all receive the same Session ID Request broadcast from the target device 110.

### The mobile phone 104 forwards the Session ID Request through a secure channel to the authoritative server 114.

### Upon receiving the request, the authoritative server 114 generates a Session ID which is associated with both the mobile phone 104 and the secure channel that was established with the mobile phone 104.

### The Session ID is associated with an internal timer of the authoritative server 114. Thus, after the expiration of a predetermined amount of time, the Session ID will become invalid.

### Step (3): The authoritative server 114 sends a Session ID Response to the mobile phone 104. The Session ID Response contains the Session ID and the URI (or IP address etc.) of the authoritative server 114.

### The mobile phone 104 forwards the Session ID Response to the target device 110.

Step (4) (see FIG. 3B): Upon receiving the Session ID Response, the target device 110 establishes a secure channel (e.g., HTTPS tunnel) with the authoritative server 114. When establishing the secure channel, the target device 110 authenticates the authoritative server 114 by checking the validity and contents of a certificate 132 provided by the authoritative server 114 with a root certificate 134. For instance, the target device 110 can check the issuer of the certificate 132, the subject, etc . . .

### Step (5): The target device 110 sends a User ID Request to the authoritative server 114 through the secure channel that was established in Step (4). The User ID Request contains the Session ID.

Step (6): The authoritative server 114 sends a User ID Response back to the target device 110 where the User ID Response contains an identifier, e.g. telephone number (or SIP URI), of the mobile phone 104 which corresponds to the Session ID assuming the Session ID is valid and has not expired. The authoritative server 114 can access the user profile database 116 and use information about the secure channel (between the authoritative server 114 and the mobile phone 104) to obtain the identifier (e.g. telephone number, or SIP URI) of the mobile phone 104.

### At the same time, the authoritative server 114 locks the Session ID to prevent other simultaneous User ID Request/Response sessions for the same Session ID.

### If the authoritative server 114 receives another User ID Request from a different target device 110 when the Session ID is locked, then the authoritative server 114 queues this request and does not immediately send the User ID Response.

When the Session ID is unlocked (the condition to unlock is described later), the authoritative server 114 pops the next User ID request from the queue and sends a User ID Response to the different target device 110. There are several possible conditions that can unlock the Session ID. One possible candidate is the timer expiration, and one is an indication from the mobile phone 104 that is initiated by an explicit user's operation, for example, pushing a ‘next’ button or a ‘cancel’ button).

### Step (7) (see FIG. 3C): Upon receiving the User ID Response, the target device 110 displays the identifier, such as the telephone number (or the SIP URI), of the mobile phone 104.

If the Session ID Request was sent as a broadcast message (in Step (2)), then the target device 110 may receive multiple Session ID Responses from multiple mobile phones 104. Then, the target device 110 sends multiple User ID Requests and receives multiple User ID Responses. If this happens, then the target device 110 displays multiple identities, e.g. telephone numbers (or the SIP URIs), of those mobile phones 104.
Step (8): The user 102 selects the appropriate user identity, e.g. telephone number (or SIP URI), of their mobile phone 104 which is displayed on the target device 110. If more than one identity, telephone numbers (or SIP URIs) are displayed, then the user 102 selects the one he/she wants to use.

### Step (9): The target device 110 sends a Key Distribution Request to the authoritative server 114.

### Step (10): After Step (8), the user 102 inputs a confirmation on the mobile phone 104 (e.g., by pushing an ‘OK’ button) to indicate that they authenticate the target device 110.

### Step (11): The mobile phone 104 sends a Key Distribution Request to the authoritative server 114.

Step (12): Upon receiving two Key Distribution Requests from the mobile phone 104 and the target device 110, the authoritative server 114 returns Key Distribution Responses to both the mobile phone 104 and the target device 110. The Key Distribution Responses each contain the same secret key that is to be subsequently shared by the mobile phone 104 and the target device 110.
Step (13): The mobile phone 104 and target device 110 establish the secure channel with each other by using the shared secret key distributed by the authoritative server 114 in Step (12). The mobile phone 104 then transfers the credential data (e.g. a certified ticket to view a particular video stream etc . . . ) over the established secure channel to the target device 110. If this step is not done, then the target device 110 will be rejected by the IMS network 106.

### The target device 110 sends the credential data (e.g., certified ticket) to the IMS operator 106 which then streams a desired video to the target device 100 (see FIG. 1).

### Exemplary Additional Features:

1. The channel between the mobile phone 104 and the target device 110 may use short range communication such as NFC, Bluetooth . . . In this case, the list of presented user identities may be limited in number. Otherwise, the channel may use exemplary W-Lan, Ethernet, PLC . . . .

2. The user 102 can initiate the method 200 by using a remote control of the target device 110. The target device 110 would respond by starting the sequence of steps 2-13 described above.

From the foregoing, it should be appreciated that the present solution discussed herein enables a mobile phone user 102 to use a VoD service subscription on their mobile phone 104 to have an IMS operator 106 stream an IMS video 108 to a target device 110 (e.g., TV terminal 110, computer terminal 110) instead of to their mobile phone 104. The present invention has several advantages some of which are as follows:

1. The present solution realizes the pairing and the establishing of a shared secret key between the mobile phone 104 (user device 104) and the TV terminal 110 (target device 119). The method 200 works under the threat of a possible man-in-the-middle attack. This is not possible with the aforementioned known 3GPP key establishment technique (reference no. 2).

2. The present solution does not require the use of extra devices for the out-of-band channel as are needed in the known talking-to-stranger technique (reference no. 3) and the known seeing-is-believing technique (reference no. 4).

3. The user 102 involvement in the paring operation between the mobile phone 104 (user device 104) and the TV terminal 110 (target device 110) is easy and minimized. This is an important feature since if the user's operation is complicated or annoying, then the user 102 would tend to skip some operations, or just not use this type of service. In the present solution, the user 102 will not skip the pairing operation because he/she can't do what he/she wants without performing this pairing operation. In contrast, the user may skip the known manual authentication technique (e.g. comparing the output of the two devices etc) because he/she can do what he/she wants without having to perform this particular operation. Plus, if the paring and the authentication can be performed simultaneously, then it is safer and more convenient for the users 102. The method 200 realizes this functionality by using normal input/output devices (not the devices of out-of-band channel as in the known stranger technique (reference no. 3) or the known seeing-is-believing technique (reference no. 4)).

4. If the user 102 selects the wrong telephone number (or SIP URI) in Step (8) and the number is unfortunately the telephone number of the malicious man-in-the-middle device 130 and the user 102 pushes the ‘OK’ button in Step (10), then the man-in-the-middle device 130 may hijack the traffic between the mobile phone 104 and the target device 110. Such risk is inevitable if the user's manual operation is involved in the process of the pairing and the authentication. But, even with this unlikely hijack scenario, the man-in-the-middle device 130 must be a valid subscriber of the authoritative server 114 (or the IMS operator 106). Then, the log of the man-in-the-middle device 130 is recorded in the operator's database. So, even if the session is hijacked, the malicious man-in-the-middle device 130 can be identified by the operator's log. This fail-safe design is yet another advantage of the present invention.

### REFERENCES

1. Yaniv Shaked, and Avishai Wool, “Cracking the Bluetooth PIN”,http://www.cs.toronto.edu/˜delara/courses/csc2228/paper s/bluetooth.pdf.
2. “Key establishment between a UICC and a terminal”, 3GPP TS 33.110 V1.0.0. (June, 2006).
3. D. Balfanz et al. “Talking to strangers: Authentication in ad-hoc wireless networks”, Symposium on Network and Distributed Systems Security, 2002-02.
4. J. M. McCune et al. “Seeing-is-believing: using camera phones for human-verifiable authentication”, Security and Privacy, 2005 IEEE Symposium on, 2005-05.
5. C. Gehrmann et al. “Mutual authentication for wireless device”, 2004-01.

Although one embodiment of the present invention has been illustrated in the accompanying Drawings and described in the foregoing Detailed Description, it should be understood that the invention is not limited to the disclosed embodiment, but instead is also capable of numerous rearrangements, modifications and substitutions without departing from the spirit of the invention as set forth and defined by the following claims.

1. A method for enabling a person to use a service subscription on a user device and have a service operator stream a video to a target device, said method comprising the steps of:
enabling a first secure channel to be established between an authoritative server and the target device;
enabling a second secure channel to be established between the authoritative server and the user device;
enabling the authoritative server to interface with a database and use information associated with the second secure channel to obtain a user identity of the user device;
enabling the authoritative server to forward the user identity to the target device which displays the user identity so the user identity can be selected by a user of the user device;
enabling the authoritative server to use the first secure channel to transfer a shared secret key to the target device;
enabling the authoritative server to use the second secure channel to transfer the shared secret key to the user device;
enabling a third secure channel to be established between the target device and the user device by using the shared secret keys;
enabling the user device to transfer credential data associated with the service subscription over the third secure channel to the target device; and
enabling the target device to send the credential data to the service operator which then streams the video to the target device.

2. The method of claim 1, wherein said first secure channel is established between the authoritative server and the target device without the authoritative server having to authenticate the target device.

3. The method of claim 1, wherein said second secure channel is established between the authoritative server and the user device after a mutual authentication between the service operator and the user device.

4. The method of claim 1, wherein said user device is a mobile phone.

5. The method of claim 1, wherein said target device is a television terminal or a computer terminal.

6. In a system including an authoritative server, a user device, a target device and a service operator, said authoritative server implements a method comprising the steps of:
receiving a session ID request over a first secure channel from the user device where the session ID request was originated at the target device;
sending a session ID over the first secure channel to the user device which in turn forwards the session ID to the target device;
establishing a second secure channel with the target device;
receiving a user ID request over the second secure channel from the target device;
obtaining a user identifier associated with the user device;
sending the user identifier over the second secure channel to the target device which then displays the user identifier to be selected by a user of the user device;
receiving a key distribution request over the second secure channel from the target device;
sending a shared secret key over the second secure channel to the target device;
receiving a key distribution request over the first secure channel from the user device after the user interacts with the user device; and
sending the shared secret key over the first secure channel to the user device, wherein the user device and the target device use the shared secret key to establish a third secure channel between them on which the user device transfers credential data to the target device which then sends the credential data to the service operator which then streams the video to the target device.

7. The method of claim 6, wherein said user device is a mobile phone.

8. The method of claim 6, wherein said target device is a television terminal or a computer terminal.

9. In a system including an authoritative server, a user device, a target device and a service operator, said target device implements a method comprising the steps of:
sending a session ID request to the user device which then sends the session ID request over a first secure channel to the authoritative server;
receiving a session ID from the user device which received the session ID over the first secure channel from the authoritative server;
establishing a second secure channel with the authoritative server;
sending a user ID request over the second secure channel to the authoritative server;
receiving a user identifier associated with the user device over the second secure channel from the authoritative server;
displaying the user identifier so the user identifier can be selected by a user of the user device;
sending a key distribution request over the second secure channel to the authoritative server after the user selects the displayed user identifier;
receiving a shared secret key over the second secure channel from the authoritative server;
using the shared secret key to establish a third secure channel with the user device which previously received the shared secret key over the first secure channel from the authoritative server;
receiving credential data over the third secure channel from the user device; and
sending the credential data to the service operator; and
receiving the video from the service operator.

10. The method of claim 9, wherein said user device is a mobile phone.

11. The method of claim 9, wherein said target device is a television terminal or a computer terminal.

12. In a system including an authoritative server, a user device, a target device and a service operator, said user device implements a method comprising the steps of:
receiving a session ID request from the target device and forwarding the session ID request over a first secure channel to the authoritative server;
receiving a session ID over the first secure channel from the authoritative server and forwarding the session ID to the target device, wherein the target device establishes a second secure channel with the authoritative server, sends a user ID request over the second secure channel to the authoritative server, receives a user identifier associated with the user device over the second secure channel from the authoritative server, displays the user identifier so the user identifier can be selected by a user of the user device, sends a key distribution request over the second secure channel to the authoritative server after the user selects the displayed user identifier, and receives a shared secret key over the second secure channel from the authoritative server;
sending a key distribution request over the first secure channel to the authoritative server;
receiving the shared secret key over the first secure channel from the authoritative server;
using the shared secret key to establish a third secure channel with the target terminal; and
sending credential data over the third secure channel to the target device which then sends the credential data to the service operator and receives the video from the service operator.

13. The method of claim 12, wherein said user device is a mobile phone.

14. The method of claim 12, wherein said target device is a television terminal or a computer terminal.
